(19) United States
(12) Patent Application Publication
(10) Pub. No.: US 2026/0321536 A1
(43) Pub. Date: Oct. 15, 2026

(54) SENSING FOR ELECTROMAGNETS

(71) Applicant: Schaeffler Technologies AG & Co. KG, Herzogenaurach (DE)

(72) Inventors: Kevin Rauh, Barberton, OH (US); Nicholas Hrusch, Wooster, OH (US)

(73) Assignee: Schaeffler Technologies AG & Co. KG, Herzogenaurach (DE)

(21) Appl. No.: 19/176,691

(22) Filed: Apr. 11, 2025

(51) Int. Cl. H01H 47/00

(52) U.S. Cl. CPC H01H 47/002

(57) ABSTRACT

A circuit includes an electromagnet having a coil and an armature that is moveable in response to energizing of the coil, switching circuitry that selectively couples direct-current (DC) power to the coil, and control circuitry that controls the switching circuitry to control the energizing of the coil, communicates an alternating-current (AC) signal to the coil at least during the energizing of the coil, determines a response to the AC signal, and determines a position of the armature based on the response.

### FIELD OF THE DISCLOSURE

The present disclosure generally relates to sensing for electromagnets. More specifically, the present disclosure relates to integrated inductive sensing of a solenoid coil.

### BACKGROUND OF THE DISCLOSURE

Electromagnets are known.

### SUMMARY OF THE DISCLOSURE

According to a first aspect of the present disclosure, a circuit includes an electromagnet having a coil and an armature that is moveable in response to energizing of the coil, switching circuitry that selectively couples direct-current (DC) power to the coil, and control circuitry that controls the switching circuitry to control the energizing of the coil, communicates an alternating-current (AC) signal to the coil at least during the energizing of the coil, determines a response to the AC signal, and determines a position of the armature based on the response.

Embodiments of the first aspect of the disclosure can include any one or a combination of the following features:
the response includes a frequency response;
the frequency response includes a first frequency corresponding to a retracted position of the armature and a second frequency corresponding to an extended position of the armature;
the control circuitry includes measurement circuitry that communicates the AC signal and determines the response, and comprising high-pass filtration circuitry electrically interposing the measurement circuitry and the coil;
the AC signal is communicated via a first node and a second node, wherein the high-pass filtration circuitry includes a first high-pass filter electrically interposing a first coil end of the coil and the first node and a second high-pass filter electrically interposing a second coil end of the coil and the second node;
a capacitor electrically interposing the first node and the second node; the switching circuitry includes a first switch electrically interposing the first coil end and a power source and a second switch electrically interposing the second coil end and the power source;
the high-pass filtration circuitry limits DC current from reaching the measurement circuitry;
the electromagnet is a solenoid;
the response is a signal indicative of an inductance of the coil;
the electromagnet includes an electromagnetic clutch of a differential assembly;
and the position is determined without the use of a magnetic sensor that detects a magnetic field created by energizing of the coil.

According to a second aspect of the present disclosure, a circuit includes an electromagnet having a coil and an armature that is moveable in response to energizing of the coil, switching circuitry that selectively couples direct-current (DC) power with the coil, and control circuitry that includes measurement circuitry. The control circuitry controls the switching circuitry to control the energizing of the coil, communicates, via the measurement circuitry, an alternating-current (AC) signal to the coil at least during the energizing of the coil, determines a response to the AC signal, and determines a position of the armature based on the response. The circuit includes high-pass filtration circuitry electrically interposing the measurement circuitry and the coil.

Embodiments of the second aspect of the disclosure can include any one or a combination of the following features:
the AC signal is communicated via a first node and a second node, wherein the high-pass filtration circuitry includes a first high-pass filter electrically interposing a first coil end of the coil and the first node and a second high-pass filter electrically interposing a second coil end of the coil and the second node;
the position is determined without the use of a magnetic sensor that detects a magnetic field created by energizing of the coil; and
the high-pass filtration circuitry limits DC current from reaching the measurement circuitry.

According to a third aspect of the present disclosure, a method for measuring a position of an armature of an electromagnet includes selectively energizing a coil of the electromagnet with direct-current (DC) power, applying an alternating-current (AC) signal to the coil at least during the energizing of the coil, determining a response to the AC signal, and determining a position of the armature based on the response.

Embodiments of the third aspect of the disclosure can include any one or a combination of the following features:
filtering DC current from the response;
the response is a signal indicative of an inductance of the coil;
and the response is an AC frequency.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:
FIG. 1 is a flowchart of a method for measuring a position of an armature of an electromagnet;
FIG. 2 is a partial cutaway view of a differential assembly incorporating an electromagnetic clutch in a disengaged condition;
FIG. 3 is a schematic of a circuit for an electromagnet;
FIG. 4 is a plot of an AC response of a circuit; and
FIG. 5 is a detailed schematic of the circuit of FIG. 3 in one example of high-pass filtration circuitry of the circuit.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to "only one" unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis. The term “circumferential” and derivatives thereof, such as “circumferentially,” shall be understood in relation to the axis of the aforementioned shaft.

Referring now to FIGS. 1-5, a circuit is generally indicated at 10. The circuit 10 includes an electromagnet having a coil 12 and an armature 14 that is moveable in response to energizing of the coil 12. The circuit 10 includes switching circuitry 16 that selectively couples direct-current (DC) power with the coil 12 and control circuitry 17 that controls the switching circuitry 16 to control the energizing of the coil 12, communicates an alternating-current (AC) signal to the coil 12 at least during the energizing of the coil 12, determines a response to the AC signal, and determines a position of the armature 14 based on the response.

According to one aspect, a method M10 for measuring a position of an armature 14 of an electromagnet includes selectively energizing a coil 12 of the electromagnet with DC power at step M12, applying an alternating-current (AC) signal to the coil 12 at least during the energizing of the coil 12 at step M14, determining a response to the AC signal at step M16, and determining a position of the armature 14 based on the response at step M18.

In some examples, the method M10 includes filtering the DC power (e.g., DC current) from the response. For example, the DC power used to energize the coil can be limited from reaching parts of the control circuitry 17 by the use of filtering devices, as will be described further herein. In this way, control circuitry 17 can control DC power to the coil 12 (for energization of the coil 12) and read a response to AC current applied to the coil 12. In some examples, the AC current applied to the coil 12 is small enough (e.g., a low-power, high-frequency signal) such that the coil is not energized via the AC current. The method M10 can be utilized for position measurement in any electromagnet application. For example, the circuit 10 and/or method M10 can provide for overlay of AC and DC signals to thereby allow for position measurement (via the AC signals) and control of the coil 12 (via the DC signals).

The circuit 10 and/or the corresponding method M10 can be implemented in conjunction with any type of electromagnet having a frequency response to energizing of its coil 12. For example, the circuit 10 can be utilized for a differential assembly 18, a solenoid, a linear actuator, a contactor, or the like. In general, the circuit 10 can provide for a non-invasive technique of determining position of the armature 14 of an electromagnet, such as an axial position of the armature 14 relative to the coil 12. For example, a position of the armature 14 can be determined without the use of a magnetic sensor that detects a magnetic field created by energizing of the coil 12.

Referring now to FIG. 2, differential assembly 18 for a vehicle can incorporate the circuit 10 for clutch engagement detection. The differential assembly 18 illustrated in FIG. 1 is one example of a differential assembly 18 that can utilize the circuit 10. Other differential assemblies having clutch systems can utilize the circuit 10.

The differential assembly 18 includes a housing 20 that encloses a gear assembly 22 and a clutch 24. The clutch 24 can incorporate the electromagnet previously described, thereby serving as an electromagnetic clutch. The clutch 24 has a first portion 26 and a second portion 28. The differential assembly 18 can be configured to connect with a drive shaft, a first axle that can couple with a first wheel, and a second axle that can couple with a second wheel. By way of example, the differential assembly 18 can be a rear differential for a vehicle having a rear left wheel and a rear right wheel. The gear assembly 22 includes a ring gear 30 that can operably couple with a drive shaft and operate as part of a drive gear assembly. A differential case 32 can be rotationally supported within the housing 20 and defines a space 34 in which a set of side gears and pinion gears 40 configured to distribute torque between the left and right axles. For example, a first gear 36 can be configured to couple with the first axle, and a second gear 38 can be configured to couple with the second axle. The first and second gears 36, 38 can be disposed on a central axis 42 about which the first and second gears 36, 38 are rotatable. The axles extend from opposite sides of the differential case 32 and are coupled to respective wheels. The differential case 32 can define an annular groove 44 having a back wall 46 through which one or more slots 47 extend axially therethrough and in which at least a portion of the clutch 24 is disposed. For example, the second portion 28 of the clutch 24 can extend through the one or more slots 47 into the space 34 and be axially moveable within the annular groove 44 to selectively interact with the first gear 36. The selective interaction of the clutch 24 with the first gear 36 provides for selective rotational coupling and decoupling of the first gear 36 with the differential case 32.

With continued reference to FIG. 2, The first portion 26 of the clutch 24 is disposed outside of the space 34 and may be movably independent from the gear assembly 22. The first portion 26 can include a casing 48 that includes ferromagnetic components that causes the casing 48 to move in response to energizing of the coil 12. Thus, the casing 48 can function as at least a portion of the armature 14. Other components that are linked with the casing 48 and move with casing 48 can also be considered at least a portion of the armature 14. The casing 48 can define a chamber 50 that extends about the central axis 42 and in which the coil 12 is disposed. The casing 48 can define an opening 52 in which an electrical connector 54 is disposed to allow electrical connection to the coil 12. For example, a cable 56 can extend from the electrical connector 54 and carry two conductors (e.g., a first conductor 58 and second conductor 60) for connection to two coil ends 62, 64 (FIG. 2) of the coil 12 in the chamber 50, respectively. The conductors 58, 60 can be coupled to control circuitry 17 to allow the control circuit 10 to control power to the coil 12 and to measure inductance of the coil 12. The coil 12 can thus act as an actuator of the electromagnet and as a sensing component of the electromagnet.

The second portion 28 of the clutch 24 can include an engaging member 68 disposed in the annular groove 44 and an intermediate assembly 70 that can guide movement of the engaging member 68 in the annular groove 44. The engaging member 68 can be a plate or annular member that is axially displaceable in the space 34. The intermediate assembly 70 includes an intermediate member 72 that extends through the one or more slots 47 to contact the engaging member 68 in the annular groove 44 at one end of the intermediate member 72 and to contact a biasing member 74 (e.g., a spring) at another end of the intermediate member 72. The biasing member 74 can be a compression spring that mechanically biases the intermediate member 72 from the engaging member 68, such that when the coil 12 is energized, the engagement member is biased toward interaction with the first gear 36. For example, the biasing member 74 can be sandwiched between the intermediate member 72 and a ring 76 that each move toward the differential case 32 when the coil is energized.

In response to electrical current flowing through the coil 12, a magnetic field can be induced, causing the casing 58, the intermediate assembly 70 (e.g., the biasing member 74, the intermediate member 72, and the ring 76), and the engagement member 68 to move axially. Thus, electrical energization of the coil 12 can cause the engaging member 68 to move to an extended position in which the engaging member 68 is engaged with the first gear 36 (as shown in FIG. 1).

In operation, when an electrical current is applied to the coil 12 (energized), a magnetic field is formed. In response to the magnetic field, the clutch 24 is moved axially from the retracted position to the extended position to engage the differential case 32 with the first gear 36. When the coil 12 is de-energized, the engaging member 68 is returned to the retracted position to disengage the first gear 36.

The clutch 24 and/or differential assembly 18 described with respect to FIG. 1 can be operable with the circuit 10 described in the forgoing figures. As previously described, other differential assemblies may incorporate the circuit 10. For example, differential assemblies can incorporate different styles of clutches. Additionally, or alternatively, other electromagnetic actuation systems may utilize the circuit 10 described herein. With respect to employment of the circuit 10 for use with the differential assembly 18, the control circuitry 17 can be remote from the gear assembly 22 and/or the clutch 24. For example, the cable 56 can allow control and monitoring of the coil 12 remotely. As will be described below, features of the control circuitry 17 can allow remote monitoring of the coil 12, thereby limiting the need for local sensors for detection of the electromagnet to fit within or near the gear assembly 22 or the clutch 24.

Referring now to FIG. 3, a circuit 10 for an electromagnet includes a coil 12 of the electromagnet, direct-current (DC) power supply circuitry 78, switching circuitry 16 electrically interposing the DC power supply circuitry 78, high-pass filtration circuitry 80, a resonant capacitor 82, and measurement circuitry 84. The control circuitry 17 can include a first controller 86 that is configured to communicate one or more signals to the switching circuitry 16 to control electrical current from the DC power supply circuitry 78. The DC power supply circuitry 78 can include a power source, such as a battery, that can provide an operating voltage (e.g., 12 VDC). The first controller 86 can have a processor 88 and a memory 90 storing instructions that, when executed by the processor 88, cause the first controller 86 to control the switching circuitry 16 to activate or deactivate the coil 12. The switching circuitry 16 can include a first switch 92 and a second switch 94 that, when activated, creates a potential across the coil 12, causing current to flow therethrough. The switches 92, 94 can be field-effect transistors (FETs), such as metal-oxide-semiconductor FETs (MOSTFETs) that are activated via relatively low-power signals from the control circuitry 17.

The measurement circuitry 84 includes an alternating current (AC) power source 96 that is configured to provide AC signals to the coil 12 via first and second nodes 98, 100. The high-pass filtration circuitry 80 includes a first high-pass filter 102 electrically interposing a first coil end 62 of the coil 12 and the first node 98 and a second high-pass filter 104 electrically interposing a second coil end 64 of the coil 12 and the second node 100. The high-pass filters 102, 104 can serve to block the energizing currents to the coil 12 (e.g., DC currents caused by activation of the switching circuitry 16) and allow high-frequency AC signals, such as AC signals from the measurement circuitry 84. The resonant capacitor 82 electrically interposes the first node 98 and the second node 100. The resonant capacitor 82 can be selected as part of the LC circuit, in conjunction with the coil 12, to provide a resonant response to the AC signals from the measurement circuitry 84. By placing the high-pass filtration circuitry 80 between the coil 12 and the first and second nodes 98, 100, the circuit 10 can limit high currents at low-frequency (e.g., at or about DC currents) from flowing into the first and second nodes 98, 100.

The measurement circuitry 84 includes a second controller 106 that is configured to read/detect/measure AC signals provided by the AC power source 96 and “reflected” back from the LC circuit. The second controller 106 can control the AC power source 96. For example, the second controller 106 and the AC power source 96 may be part of a common integrated circuit (IC) configured to detect inductance. The second controller 106 can have a processor 108 and a memory 110 storing instructions that, when executed by the processor 108, cause the second controller 106 to control the AC power source 96 to communicate an AC signal and to detect a response to the AC signal from the coil 12. Thus, the first and second nodes 98, 100 are operable to carry an “output” (the AC signal) and an “input” (the response).

The resonant capacitor 82 between the first and second nodes 98, 100 can provide to the measurement circuitry 84 a filtered signal that allows the measurement circuitry 84 to distinguish between frequency responses of the coil 12. The capacitor 82 can be sized such that, in conjunction with the inductance of the coil 12, an LC circuit having a resonant frequency is formed. This frequency is measured by the measurement circuitry 84 as the response. The position of the armature 14 can be logically linked to the frequency, such as in a look-up table stored in one or more of the memories 90, 110. When the coil 12 changes condition from energized to de-energized, or vice versa, the armature 14 is moved, thereby causing induced eddy currents in the coil 12. These small currents cause a frequency response in the LC circuit, which is detected by the measurement circuitry 84. Thus, the measurement circuitry 84 can detect changes in frequency of the LC circuit 10, which is indicative of changes in inductance of the coil 12, which is indicative of the position of the armature 14.

With continued reference to FIG. 3, the first controller 86 and the measurement circuitry 84 can be part of the control circuitry 17. For example, the control circuitry 17 can be part of a common control unit, which can include the switching circuitry 16, to which the first and second conductors 58, 60 connect. While demonstrated as two controllers 86, 106, it is contemplated that a common controller can be provided in some examples. In the present example, the first controller 86 can communicate signals to the switching circuitry 16 to control energizing of the coil 12, utilize feedback from the measurement circuitry 84 (e.g., a frequency) to determine the position of the armature 14, and control the switching circuitry 16 based on a determined position. For example, a stuck condition of the armature 14 can be detected, and activation or deactivation of the switching circuitry 16 can be controlled based on the stuck condition. In some examples, the position of the armature 14 (e.g., the retracted position, the extended position, any position therebetween) can be processed by the control circuitry 17 to determine a fault of the armature 14, a reaction time, or any other parameter related to movement of the armature 14.

Referring now to FIG. 4, a response of the coil 12 to an AC signal provided by the measurement circuitry 84 is indicated in a plot 112 in the form of an AC signal. As shown, the response can include a first signal at a first frequency f₁ corresponding to the frequency response of the coil 12 at a first position of the armature 14 and a second signal at a second frequency f₂ corresponding to the frequency response of the coil 12 at a second position of the armature 14. The AC signals communicated via the measurement circuitry 84 can be high-frequency. For example, they may be in the range of hundreds of kilo-Hertz (kHz) or greater. By way of example, the AC signals and the response can be in the range of between 1 kHz and 1,000 kHz. The various frequencies detectable by the measurement circuitry 84 can be within a small percentage of one another. In some examples, the frequency response includes the first frequency f₁ corresponding to the retracted position and the second frequency f₂ corresponding to the extended position. The first frequency f₁ can be within 10% of the second frequency f₂. In some examples, the first frequency f₁ is within 5% of the second frequency f₂. The minor differences in frequency can be measured by the measurement circuitry 84, and the control circuitry 17 can determine a position of the armature 14 according to these minor differences.

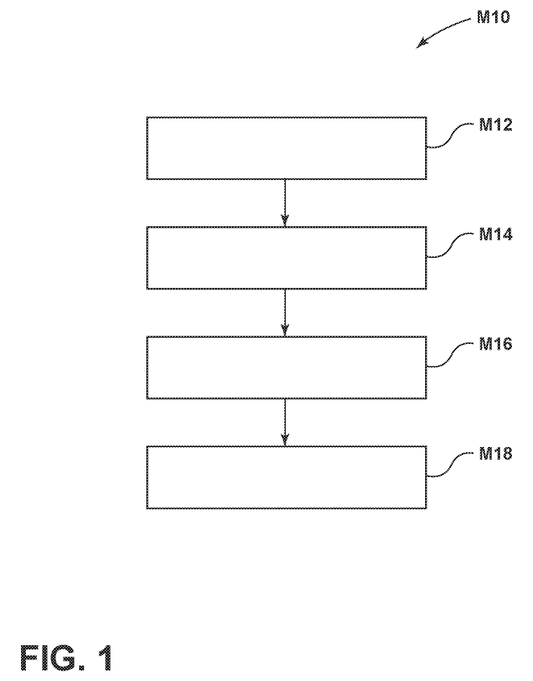

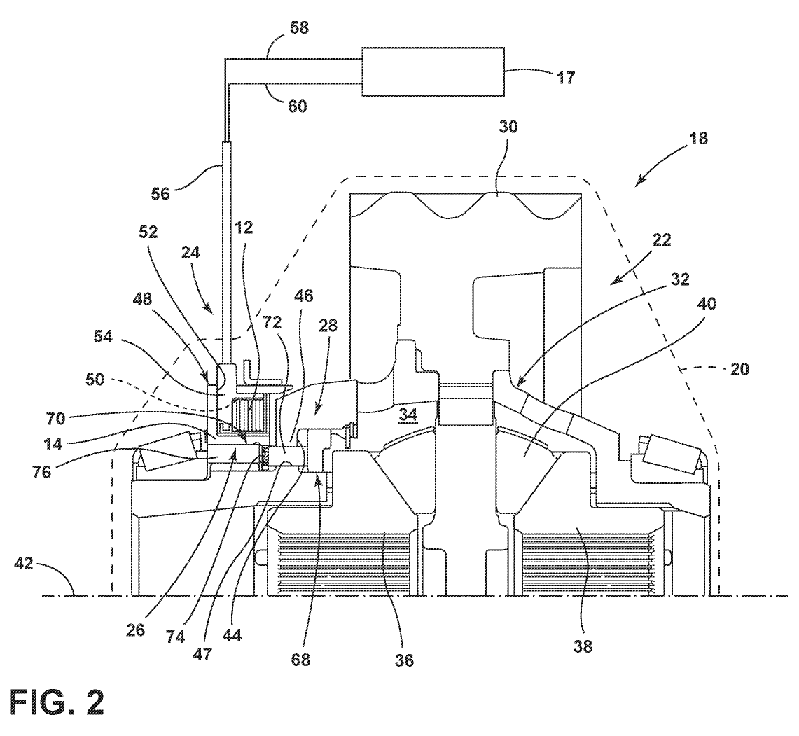

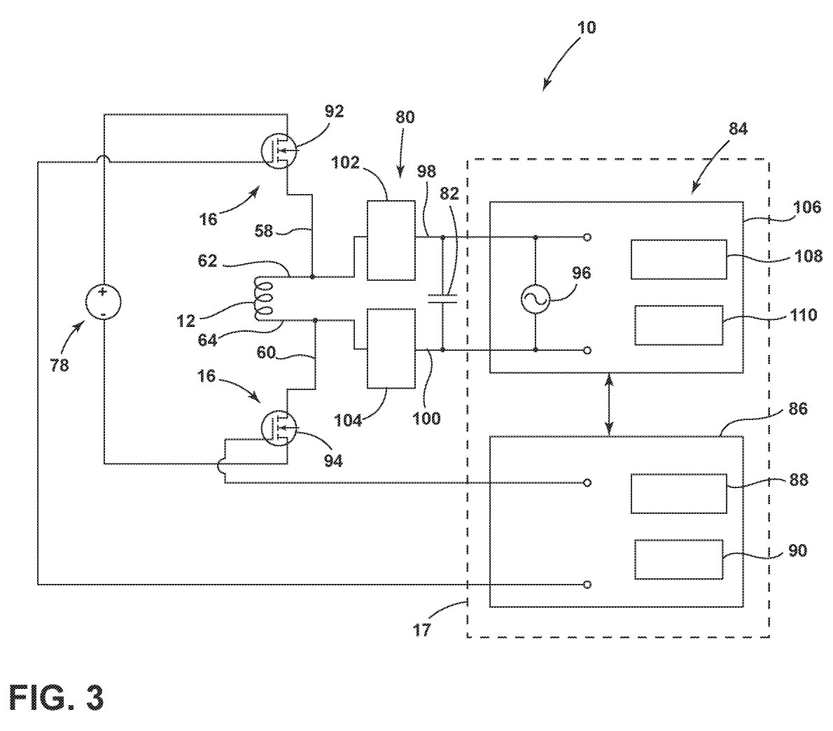

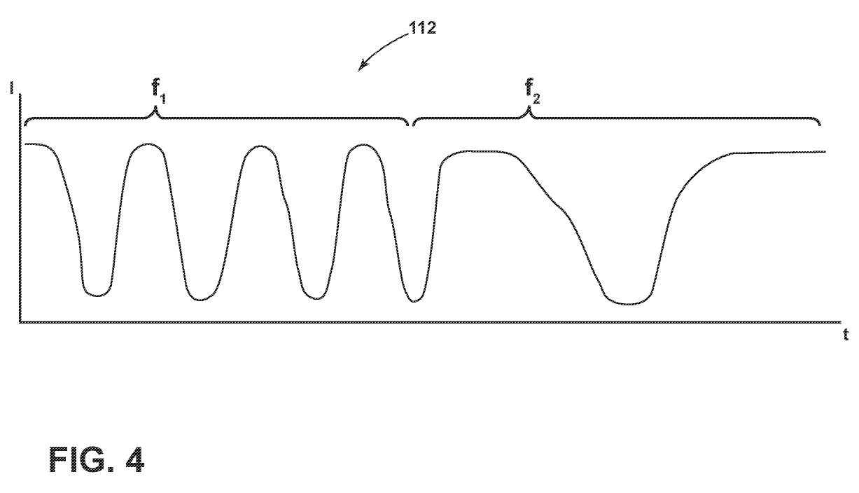

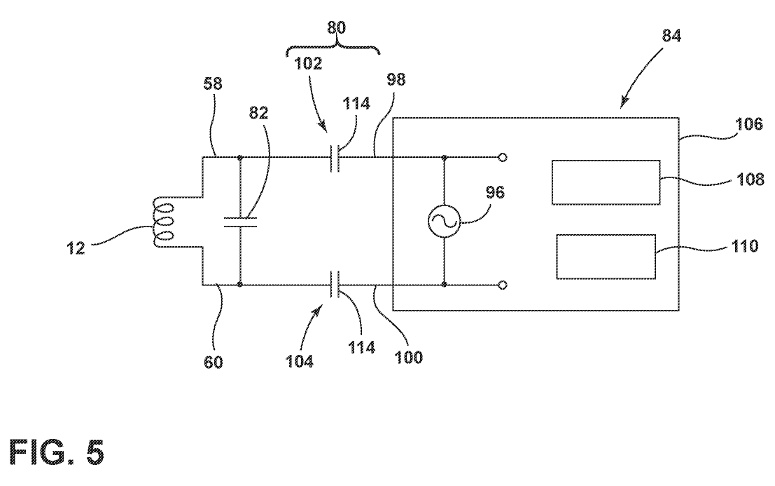

Referring now to FIG. 5, it is demonstrated that each of the high-pass filters 102, 104 can incorporate a filtering capacitor 114 that is configured to limit DC current from flowing toward the measurement circuitry 84. In some examples, other circuitry can be provided between the measurement circuitry 84 and the coil 12, such as voltage divider. For example, the measurement circuitry 84 may be operable on a low voltage (e.g., 3V) relative to the DC power supply circuitry 78 (e.g., 12V).

In operation, the first controller 86 can communicate signals to cause the switching circuitry 16 to conduct current through the coil 12. During the activation, the measurement circuitry 84 communicates the AC signals through the coil 12 and measures the response. The high-pass filtration circuitry 80 blocks DC current from reaching the measurement circuitry 84. The first controller 86, the second controller 106, or another controller in communication with the second controller 106, determines a position of the armature 14 based on the response. The position can be compared to a command position using a look-up table or another data structure to detect a fault or to otherwise perform diagnostics on the electromagnet. The second controller 106 can also detect the position, or a position change, when the coil 12 transitions from the energized state to the de-energized state or during steady state. For example, the position can be detected by the control circuitry 17 when the armature 14 is not being moved and/or when it is moving.

In some examples, the AC signals are continuously transmitted and received through the coil 12. Thus, at least during the control of the coil 12, an AC wave is superimposed over the DC component of current through the coil 12. By providing the high-pass filtration circuitry 80 between the coil 12 and the measurement circuitry 84, the DC current can be limited from reaching the measurement circuitry 84. In this way, both AC and DC signals can be applied to the coil 12 simultaneously while not interfering with one another.

In some examples, the differential assembly 18 described with respect to FIG. 2 incorporates the circuit 10 to determine engagement of the engaging member 68 with the first gear 36 to determine rotational coupling with the differential case 32. The control circuitry 17 can determine the position of the engaging member 68. The position can be a relative axial position of the engaging member 68 in the annular groove 44 or a relative axial position of any part of the armature 14.

The circuit 10 can be employed for any electromagnet and is not limited to application in a differential assembly 18. For example, the circuit 10 can be utilized in conjunction with a solenoid valve, a motor, a contactor, or any other component that includes an electromagnet. In some examples the position is represented as two positions—the extended position and the retracted position. In some examples, the position is represented as a continuous reading. For example, the response can be classified based on the value (e.g., a frequency value). In general, the present circuit 10 can provide for cost savings and space management by omitting a separate dedicated magnetic or inductance sensor within the structure of that houses the electromagnet. Integrating the sensor into the electromagnet itself removes the need for additional boards and sensing elements. Additional control and signal conditioning can be done remotely at the where a circuit board is already provided, helping reduce the overall system cost.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 circuit
12 coil
14 armature
16 switching circuitry
17 control circuitry
18 differential assembly
20 housing
22 gear assembly
24 clutch
26 first portion
28 second portion
30 ring gear
32 differential case
34 space
36 first gear
38 second gear
40 pinion gears
42 central axis
44 annular groove
46 back wall
47 slot
48 casing
50 chamber
52 opening
54 electrical connector
56 cable
58 first conductor
60 second conductor
62 first coil end
64 second coil end
68 engaging member
70 intermediate assembly
72 intermediate member
74 biasing member
76 ring
78 DC power supply circuitry
80 high-pass filtration circuitry
82 resonant capacitor
84 measurement circuitry
86 first controller
88 processor
90 memory
92 first switch
94 second switch
96 AC power source
98 first node
100 second node
102 first high-pass filter
104 second high-pass filter
106 second controller
108 processor
110 memory
112 plot
114 filtering capacitor

What is claimed is:

1. A circuit, comprising:
an electromagnet having a coil and an armature that is moveable in response to energizing of the coil;
switching circuitry that selectively couples direct-current (DC) power with the coil; and
control circuitry that:
controls the switching circuitry to control the energizing of the coil;
communicates an alternating-current (AC) signal to the coil at least during the energizing of the coil;
determines a response to the AC signal; and
determines a position of the armature based on the response.

2. The circuit of claim 1, wherein the response includes a frequency response.

3. The circuit of claim 2, wherein the frequency response includes a first frequency corresponding to a retracted position of the armature and a second frequency corresponding to an extended position of the armature.

4. The circuit of claim 2, wherein the control circuitry includes measurement circuitry that communicates the AC signal and determines the response, and comprising:
high-pass filtration circuitry electrically interposing the measurement circuitry and the coil.

5. The circuit of claim 4, wherein the AC signal is communicated via a first node and a second node, wherein the high-pass filtration circuitry includes a first high-pass filter electrically interposing a first coil end of the coil and the first node and a second high-pass filter electrically interposing a second coil end of the coil and the second node.

6. The circuit of claim 5, comprising:
a capacitor electrically interposing the first node and the second node.

7. The circuit of claim 5, wherein the switching circuitry includes a first switch electrically interposing the first coil end and a power source and a second switch electrically interposing the second coil end and the power source.

8. The circuit of claim 4, wherein the high-pass filtration circuitry limits DC current from reaching the measurement circuitry.

9. The circuit of claim 1, wherein the electromagnet is a solenoid.

10. The circuit of claim 1, wherein the response is a signal indicative of an inductance of the coil.

11. The circuit of claim 1, wherein the electromagnet includes an electromagnetic clutch of a differential assembly.

12. The circuit of claim 1, wherein the position is determined without the use of a magnetic sensor that detects a magnetic field created by energizing of the coil.

13. A circuit, comprising:
an electromagnet having a coil and an armature that is moveable in response to energizing of the coil;
switching circuitry that selectively couples direct-current (DC) power with the coil;
control circuitry including measurement circuitry, wherein the control circuitry:
controls the switching circuitry to control the energizing of the coil;
communicates, via the measurement circuitry, an alternating-current (AC) signal to the coil at least during the energizing of the coil;
determines a response to the AC signal; and
determines a position of the armature based on the response; and
high-pass filtration circuitry electrically interposing the measurement circuitry and the coil.

14. The circuit of claim 13, wherein the AC signal is communicated via a first node and a second node, wherein the high-pass filtration circuitry includes a first high-pass filter electrically interposing a first coil end of the coil and the first node and a second high-pass filter electrically interposing a second coil end of the coil and the second node.

15. The circuit of claim 13, wherein the position is determined without the use of a magnetic sensor that detects a magnetic field created by energizing of the coil.

16. The circuit of claim 13, wherein the high-pass filtration circuitry limits DC current from reaching the measurement circuitry.

17. A method for measuring a position of an armature of an electromagnet, comprising:
selectively energizing a coil of the electromagnet with direct-current (DC) power;
applying an alternating-current (AC) signal to the coil at least during the energizing of the coil;
determining a response to the AC signal; and
determining a position of the armature based on the response.

18. The method of claim 17, comprising:
filtering DC current from the response.

19. The method of claim 17, wherein the response is a signal indicative of an inductance of the coil.

20. The method of claim 17, wherein the response is an AC frequency.
